(19) United States
(12) Patent Application Publication
(10) Pub. No.: US 2026/0044983 A1
(43) Pub. Date: Feb. 12, 2026

(54) AUTOMATED METHOD FOR DIGITAL IMAGE ACQUISITION SYSTEM CALIBRATION

(71) Applicant: SCHLUMBERGER TECHNOLOGY CORPORATION, Sugar Land, TX (US)

(72) Inventors: Matthias FRANCOIS, Clamart (FR); Can Evren YARMAN, Clamart (FR); Francois WANTZ, Clamart (FR)

(21) Appl. No.: 19/139,891

(22) PCT Filed: Jan. 24, 2024
(86) PCT No.: PCT/US2024/012747

§ 371 Date: Jun. 17, 2025

(30) Foreign Application Priority Data
Jan. 24, 2023 (EP) 23305090.5

(51) Int. Cl. G06T 7/80; G06T 7/11; G06T 7/136; G06T 7/149; G06T 7/73

(52) U.S. Cl. CPC G06T 7/80; G06T 7/11; G06T 7/136; G06T 7/149; G06T 7/73; G06T 2207/30208

(57) ABSTRACT

A method for calibrating a digital image acquisition system includes acquiring a digital image of a calibration target. Locations of each of a plurality of identifying features in the calibration target are determined and distances are computed between selected ones of the plurality of identifying features. A calibration grid is computed and overlay ed on the acquired digital image. The calibration grid is computed from a location of a reference one of the plurality of identifying features in the acquired digital image, the computed distances between the selected ones of the plurality of identifying features, and known locations of the plurality of calibration regions with respect to the reference one of the plurality of identifying features in the calibration target. The calibration grid specifies a plurality of calibration areas that correspond to the plurality of calibration regions in the calibration target.

### CROSS REFERENCE TO RELATED APPLICATIONS

The present application claims priority benefit of European Patent Application No. 23305090.5, filed Jan. 24, 2023, the entirety of which is incorporated by reference herein and should be considered part of this specification.

### BACKGROUND

Calibrated image acquisition is utilized in numerous image processing and artificial intelligence based image evaluation applications. Such calibrated image acquisition is intended to provide high quality images under robust, repeatable, and quantitatively verifiable conditions. Digital images acquired from a calibrated image acquisition system are intended to be acquired under similar conditions having desired criteria such as brightness, color contrast, sharpness, and the like.

Known calibration procedures commonly include acquiring a digital image of a calibration target such as a color checker. Commonly used color checkers include various color regions to calibrate color contrast and lighting conditions and transition areas for measuring image sharpness to calibrate focus and other camera settings. These calibration procedures generally involve extensive manual interaction, for example, to precisely position the color checker on a stand and then to identify the individual color regions and transition areas in an image for system calibration. The calibration procedures further provide for the user to manually adjust lighting and camera settings.

While known calibration procedures may be serviceable, they tend to be time consuming and user dependent such that different operators commonly arrive at different system calibrations. There is a need in image processing applications, particularly for artificial intelligence based image evaluation applications, for an automated calibration procedure that provides for rapid and consistent system calibration.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example digital image of cuttings particles obtained during a downhole drilling operation.

FIGS. 2A and 2B flow charts of example calibration methods disclosed herein.

FIGS. 3A-3E (collectively FIG. 3) depict images of an example calibration target that further illustrate the method of FIG. 2B.

FIGS. 4A-4C (collectively FIG. 4) depict calibration grids computed using the method of FIG. 2B overlaying a calibration target at three distinct locations and rotational orientations with the field of view of corresponding acquired images.

FIGS. 5A and 5B (collectively FIG. 5) depict calibration grids computed using the method of FIG. 2B overlaying a calibration target at two distinct luminosities.

FIG. 6 depicts an example digital acquisition system.

FIG. 7 depicts a flow chart of another disclosed calibration method.

### DETAILED DESCRIPTION

Embodiments of this disclosure include systems and methods for calibrating a digital image acquisition system. One example method includes acquiring a digital image of a calibration target using a digital image acquisition system. The calibration target includes a plurality of calibration regions and a plurality of identifying features. Locations of each of the plurality of identifying features in the digital image are determined and distances are computed between selected ones of the plurality of identifying features. A calibration grid is computed and overlayed on the acquired digital image. The calibration grid is computed from a location of a reference one of the plurality of identifying features in the acquired digital image, the computed distances between the selected ones of the plurality of identifying features, and known locations of the plurality of calibration regions with respect to the reference one of the plurality of identifying features in the calibration target. The calibration grid specifies a plurality of calibration areas that correspond to the plurality of calibration regions in the calibration target.

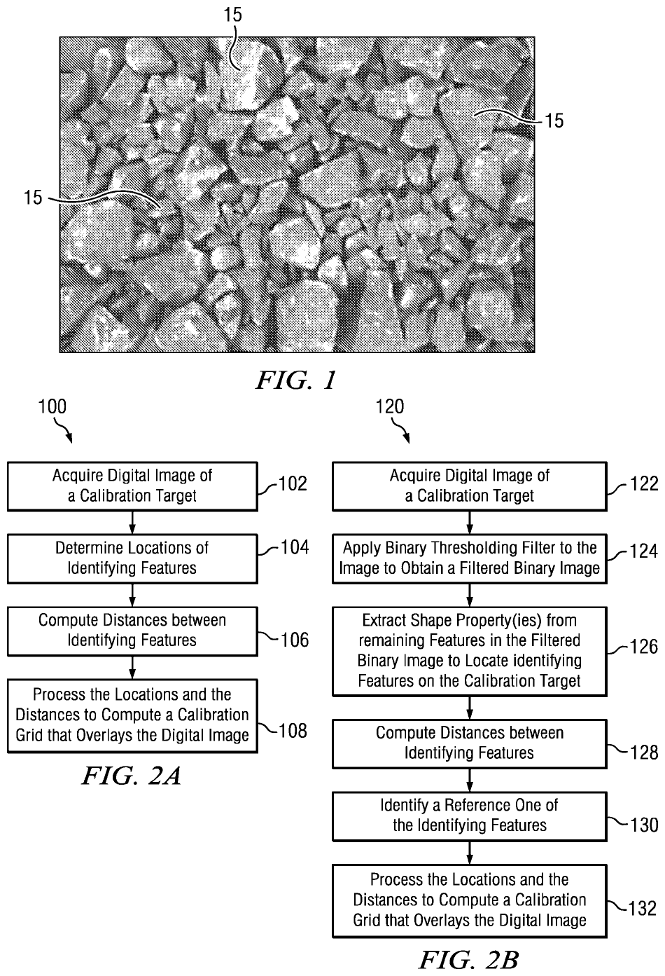

FIG. 1 depicts an example digital image of cuttings particles obtained during a downhole drilling operation. The depicted image includes a large number of cuttings particles 15 placed on a tray. It has long been recognized that rock cuttings particles generated during drilling are abundant in volume and number and may potentially provide one of the lowest cost and most abundant data sources for understanding and characterizing the subsurface formation(s). In recent years there has been considerable interest in developing methods that make use of machine learning (e.g., artificial intelligence and neural network processing) to evaluate the cuttings particles (such as those depicted in FIG. 1).

For example, methods have been disclosed to classify formation lithology from digital images of cuttings particles. Such methods may include acquiring a calibrated digital image of the cuttings particles, segmenting the image to identify individual particles in the image, extracting geometry, color, and/or texture features from the individual particles, and processing the extracted features to classify the lithology of the formation from which the cuttings were obtained.

It will be appreciated that segmentation and subsequent feature extraction may be highly influenced by the quality of the acquired digital image. For example, a blurry image may significantly increase the difficulty in identifying individual particles during segmentation and/or extracting features from the individual particles (particularly texture related features). Moreover, improper lighting (e.g., too much or too little light or improper lighting color) may reduce image contrast and may therefore also complicate segmentation and feature extraction. Inconsistent focus and lighting may also increase the difficulty of evaluating (or correlating) the extracted features with particular formation properties or classifications.

Calibration methods have been developed to improve the quality and consistency of acquired digital images. For example, calibrating a digital image acquisition system may include using standardized and/or calibrated lighting, color enhancement, magnification, and/or focus/resolution settings. In some applications, color/illumination calibration is obtained by using colorimetry algorithms against previously analyzed photos and a current photo of interest, while resolution calibration may be based on lens focal length, focal distance, and sensor size/resolution for the current photo of interest as compared to that of previously analyzed photos. Images may be taken when the cuttings are wet or dry, with the humidity generally being controlled for dry cuttings images. Calibration procedures may include evaluating one or more images of a standard calibration target such as a color checker and then making adjustments to system lighting, magnification, and/or focus/resolution settings in response to the image evaluation.

FIGS. 2A and 2B (collectively FIG. 2) depict flow charts of example calibration methods 100 and 120 for calibrating a digital image acquisition system. The disclosed embodiments may be used to calibrate substantially any suitable digital image acquisition system configured for acquiring digital images of substantially any suitable object or objects. While the disclosed embodiments are described with respect to taking calibrated images of drill cuttings (e.g., as depicted in FIG. 1), the disclosed calibration methods are expressly not limited to oilfield applications or to images of drill cuttings.

In FIG. 2A, method 100 includes using a digital acquisition system to acquire a digital image of a calibration target at 102. As described in more detail below, the calibration target may include, for example, a plurality of colored regions (e.g., colored squares), an edge contrast region, and a plurality of spaced apart identifying features. The image is processed at 104 to determine the locations of the plurality of identifying features, including a reference one of the identifying features. By reference it is meant one of the plurality of identifying features that acts as a reference location to which other features in the calibration target are referenced. A distance (or distances) between at least first and second of the identifying features is/are then computed at 106 (e.g., in pixel units). The locations of the identifying features and the distances therebetween are then processed in combination with a known geometric layout of the calibration target at 108 to compute a calibration grid. The calibration grid includes a plurality of calibration areas that overlay the colored regions and the edge contrast region in the calibration target and may be defined, for example, by a unique set of pixels in the acquired image.

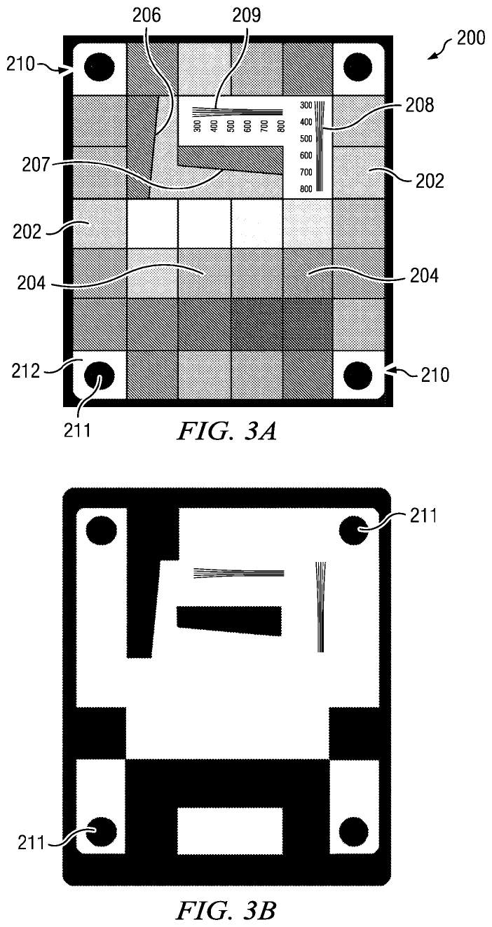

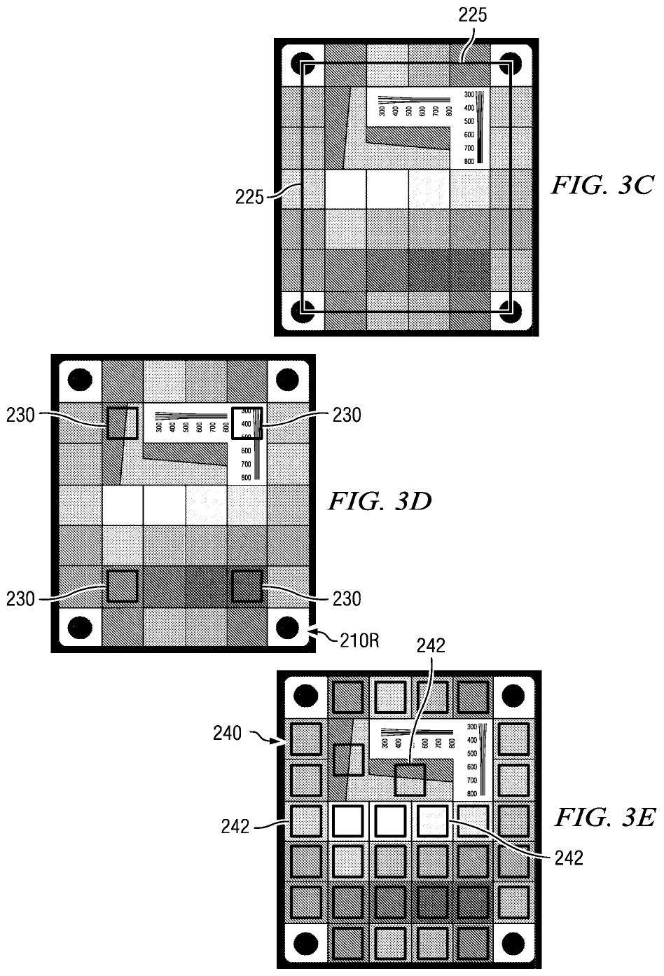

With continue reference to FIG. 2A, the calibration grid may be computed, for example, using the center location of the identifying features. The center of the one of the identifying features (such as the reference feature) may be defined as the origin and the location of each calibration region may be defined with respect to the origin. The locations of the calibration areas may be computed, for example, using a rectangular coordinate system via computing a unit vector between the reference feature and other feature or using a radial coordinate system via computing a distance and angular orientation between the reference feature and other feature. For example, two perpendicular unit vectors may be computed between the reference feature and another feature in the calibration checker (such as an adjacent feature in the calibration checker). Each element in the calibration grid is then a combination of a₁u+a₂v where u and v are the perpendicular unit vectors and a₁ and a₂ are integers defining the locations of the calibration regions on the grid (e.g., in the 6×7 grid used in the example calibration checker depicted on FIGS. 3-5).

Method 120 is now described in more detail with respect to FIGS. 2B and 3A-3E (collectively FIG. 3). Method 120 includes using a digital acquisition system, e.g., including a digital camera, to acquire a digital image of a calibration target at 122. One example calibration target is depicted in FIG. 3A. This example calibration target 200 (e.g., a Rez Checker target available from Imatest) includes a plurality of calibration regions distributed in a 6×7 grid. The calibration regions include colored calibration regions 202 (e.g., colored squares), grey scale calibration regions 204 (e.g., grey squares), an edge contrast region (e.g., including an angled horizontal edge 206 and an angled vertical edge 207), a wedges region (e.g., including horizontal wedges 208 and vertical wedges 209), and four identifying features 210 (e.g., dark circulars in a light background) located at the corresponding corners of the calibration target 200. It will be understood that in FIG. 3A the colored calibration regions 202 are shown in grey scale for ease of illustration. In the example calibration target depicted, these colored calibration regions 202 are located along the outer edges of the calibration target 200 (18 in this example, 5 colored squares along each long side and 4 colored squares along each short side of the target). The grey scale calibration regions 204 (also shown in grey scale on FIG. 3A) are located in an internal region of the calibration target 200 (12 grey squares in this example in a 3×4 grid). In the depicted example, calibration target 200 is laid out in a 6×7 grid and includes 18 colored calibration regions 202, 12 grey scale calibration regions 204, two edge contrast regions 207, 208 and two wedges regions 211, 212, each of which occupies a 1×2 grid, and the four identifying features 210, each of which includes a black circle 211 in a white background square 212.

With continued reference to FIG. 2B, at 124 a binary thresholding filter is applied to the image to obtain a filtered binary image in which certain features of the calibration target remain (particularly the identifying features 210). The binary thresholding filter value may be advantageously selected such that many of the colored calibration regions 202 and the grey scale calibration regions 204 are removed, thereby leaving only the darker features in the image (particularly the black circles 211 in FIG. 3A in the depicted example). On example of a filtered binary image is shown on FIG. 3B.

At 126, one or more shape properties may be extracted from each remaining feature in the filtered binary image. For example, the circularity of each remaining feature may be evaluated at 126. In the depicted embodiment, the features having the highest circularity (or the features having a circularity greater than a threshold) may be retained and classified as the identifying features (e.g., the four dark circles 211 in FIG. 3B). The center location of each identifying feature (or circle) may be further computed at 126.

At 128, distances (e.g., in number of pixels) between the centers of the identified features 210 may be computed. For example, the distances between a first identifying feature (the reference feature) and each of the other identifying features may be computed at 128. Likewise, distances between a second identifying feature and third and fourth identifying features may also be computed at 128. A distance between third and fourth identifying features may be further computed at 128. FIG. 3C depicts an embodiment in which four identifying features are located at the corners of the calibration checker and in which the distances between identifying features along the edges of the calibration checker are computed at 128 (as shown at 225). These distances may be further processed to compute the physical dimensions of the calibration checker in pixels as well as the size of the individual calibration regions (e.g., the squares) in the calibration target.

With further reference to FIG. 2B, a reference one 210R of the identifying features 210 may be uniquely identified (or classified) at 130. The reference feature 210R may be identified, for example, by evaluating other regions on the calibration checker. In the example embodiment depicted, the reference feature may be identified by evaluating regions 230 that are located diagonally inwards from each of the identifying regions 210 as shown on FIG. 3D. In this particular example, the average intensity of each of the evaluating regions 230 is computed at 130 and the reference feature 210R is identified as the identifying feature 210 that is adjacent to the darkest (lowest intensity) evaluating region 230. It will, of course, be understood that the disclosed embodiments are not limited in this regard as the reference feature might instead be adjacent to the lightest (highest intensity) evaluating region or to an evaluating region that includes an edge or wedges feature. Moreover, the selected evaluating regions 230 are not necessarily adjacent to the identifying features 210.

A calibration grid 240 may be computed and overlayed on the image at 132. In the example embodiment depicted, the calibration grid includes a plurality of areas 242 (or regions) that overlay the colored regions, the grey regions, and the edge contrast region in the calibration target and may be defined, for example, by a unique set of pixels in the acquired image as described above with respect to FIG. 2A. An example calibration grid 240 is depicted on FIG. 3E and includes the above described calibration areas 242. The calibration grid 240 may be computed, for example, from the known locations of the plurality of calibration regions with respect to a reference one of the plurality of identifying features in the calibration target, the location(s) of the identifying features or the reference feature determined at 126, 130, and the distances between the identifying features computed at 128. Stated another way, the computed distances 225 between the identifying features define the size of the color checker in the image (e.g., in pixel units). For example, in the embodiment depicted on FIG. 3C, the distances are equal to 5 and 6 grid units respectively. The center location of each area in the calibration grid may then be computed as a distance (e.g., in pixel units) multiplied by a two dimensional grid position, where the grid position is a hard-coded value based on the known layout of the calibration checker.

It will be appreciated that the disclosed embodiments advantageously tend not to be sensitive to the location and angular orientation of the color checker in the field of view of the acquired image. Moreover, the disclosed embodiments advantageously further tend not to be sensitive to image lighting (e.g., the luminosity of the image).

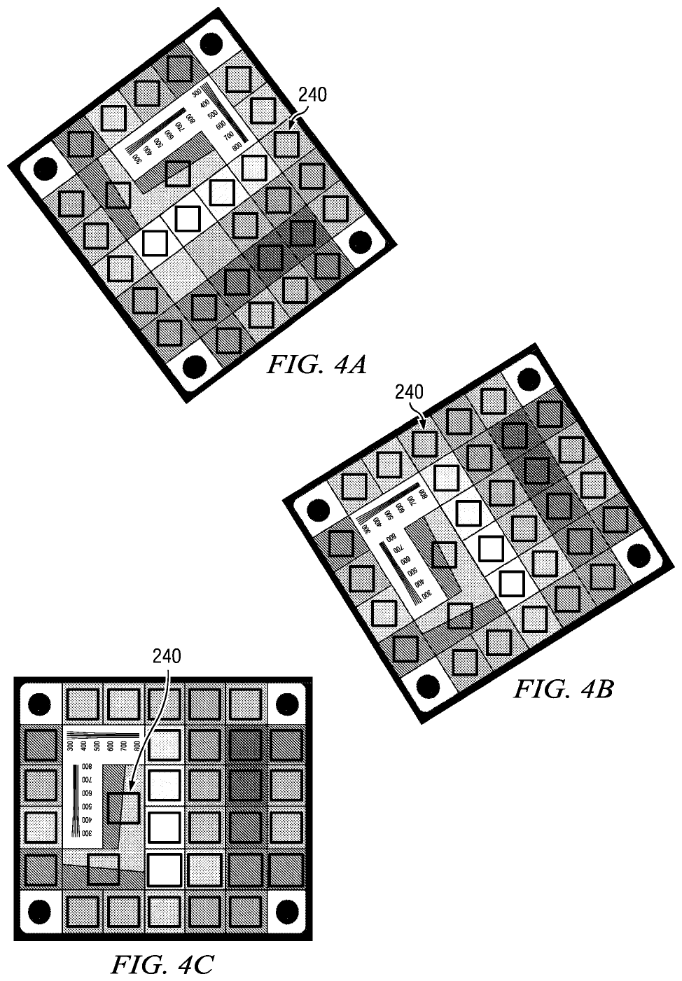

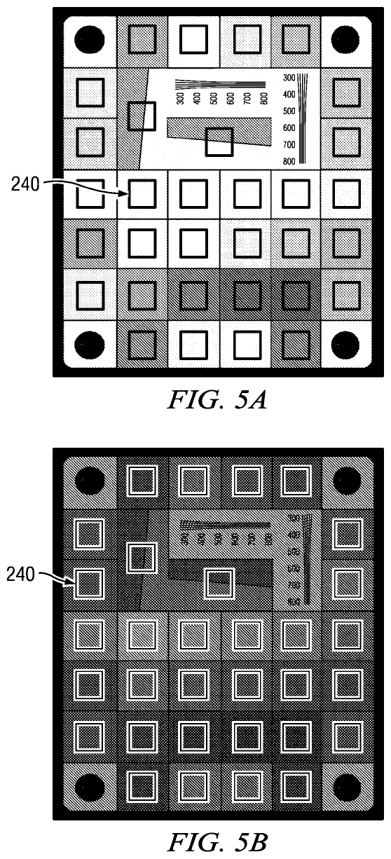

FIGS. 4A-4C (collectively FIG. 4) depict calibration grids overlaying the example color checker computed using method 120 (FIG. 2B) for three distinct color checker locations and rotational orientations with the field of view of the acquired images. Note that in each example, the calibration grid correctly overlays the corresponding calibration regions on the calibration target. FIGS. 5A and 5B (collectively FIG. 5) depict calibration grids overlaying the example calibration target computed using method 120 (FIG. 2B) for images having high and low luminosity. Note that in each example, the calibration grid correctly overlays the corresponding calibration regions on the calibration target.

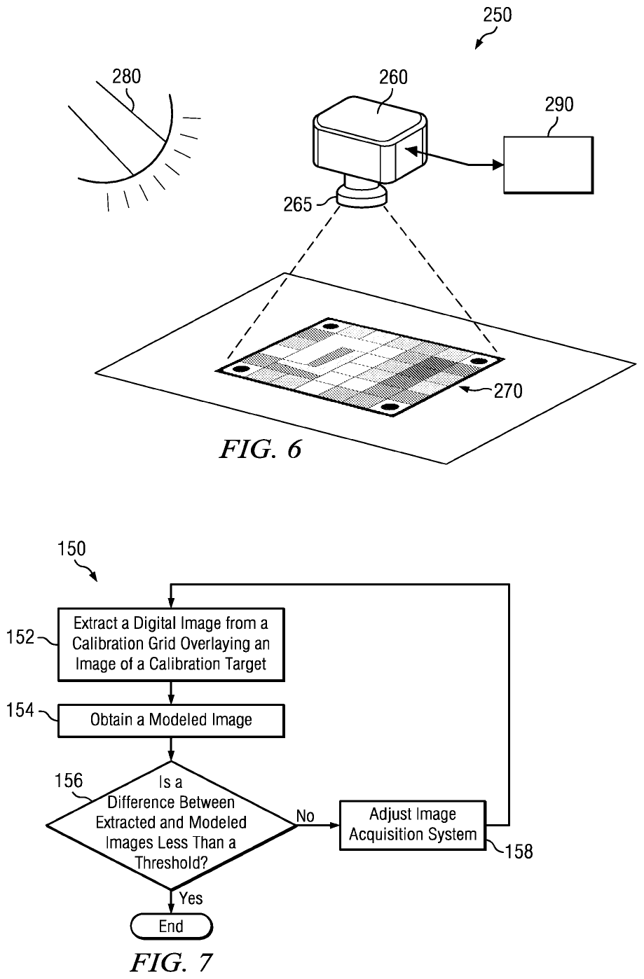

Turning now to FIG. 6, one example digital image acquisition system 250 suitable for acquiring digital images at 102 and 122 of methods 100 and 120 (FIG. 2) is depicted. The example system 250 includes a digital camera 260 including a lens 265 such as a zoom lens or a microscopic zoom lens for taking digital images of an object. The digital camera 260 and lens 265 may include substantially any suitable camera for taking digital images. It will be appreciated that a digital camera, as the term is used herein, is substantially any suitable hardware device that captures digital photographs and stores the digital photographs to digital memory, such as a camera, a smartphone, a tablet, and a webcam. In the depicted embodiment, the digital camera 260 is deployed above an example calibration target 270, such as the calibration targets shown on FIGS. 3, 4 and 5. The system may further optionally include a light source 280 configured to illuminate the calibration target.

With continued reference to FIG. 6, in example embodiments the digital camera 260 may be electronically connected/coupled with an electronic controller 290. The electronic connection may be configured such that digital images may be transmitted from the digital camera 260 (e.g., from digital memory in the camera) to the controller 290 and such that instructions/commands may be transmitted from the controller 290 to the camera 260. The controller 290 may include computer hardware and software configured to automatically or semi-automatically evaluate images obtained from the digital camera (e.g., using the disclosed method embodiments such as methods 100, 120, and/or 150). To perform these functions, the hardware may include one or more processors (e.g., microprocessors) which may be connected to one or more data storage devices (e.g., hard drives or solid state memory). As is known to those of ordinary skill, the processors may be further connected to a network or another computer system. It will, of course, be understood that the disclosed embodiments are not limited the use of or the configuration of any particular computer hardware and/or software.

FIG. 7 depicts a flow chart of a method 150 for calibrating a digital image acquisition system. An image segment (or segments) may be extracted from a corresponding calibration region (or regions) in a calibration grid overlaying an acquired digital image of a calibration target at 152. The calibration grid is computed for the calibration target, for example, using one of methods 100 and 120. Modeled (synthetic) images are obtained (or computed) at 154 for the corresponding region(s) of the calibration grid. The modeled image may be obtained using substantially any suitable techniques depending on the calibration grid region as described in more detail below. Method 150 further includes comparing the image segment(s) and the modeled image(s) at 156. When a difference (or a sum of the differences) between the image segment(s) and the modeled image(s) is less than the threshold, the image acquisition system is taken to be optimized (or calibrated). When the difference (or a sum of the differences) is greater than the threshold, the image acquisition system is adjusted at 158. The method then returns to 152 and the acquisition of another image. The adjustment(s) to the image acquisition system at 158 may include substantially any suitable adjustment, for example, including camera settings, light source settings, atmospheric conditions, and/or any other operational parameter that influences image quality.

With continued reference to FIG. 7, the modeled image(s) obtained at 154 may include reference colors (e.g., including reference red, green, and blue values) corresponding to particular ones of the colored calibration regions 202, reference intensities (or shades of grey) corresponding to particular ones of the grey scale calibration regions 204, or modeled edge or wedge images corresponding to particular ones of the edge contrast regions 206, 207 or wedges regions 208, 209. Modeled edge images may be computed, for example, using a mathematical model. The modeled image may be computed using substantially any suitable mathematical relations, for example, including a Bessel function or a Gaussian function. A difference between the image segment and the modeled image may be minimized by adjusting model parameters to estimate the spatial resolution of the digital imaging system (e.g., a spatial frequency resolution). The parameters may include, for example, a Gaussian variance. The image acquisition may be adjusted (e.g., adjusting a focus) and the method repeated to improve the spatial resolution (e.g., the spatial frequency response of the system).

Comparing the acquired image(s) and the modeled image(s) at 156 may include comparing a single (unitary) extracted image segment and a corresponding single (unitary) modeled image or may include comparing a plurality of extracted image segments (e.g., of a plurality of calibration regions) with a corresponding plurality of modeled images. For example, image segments of each of the colored calibration regions may be compared with corresponding modeled images of each of the same colored calibration regions. In such an embodiment, the comparison may include computing a sum (or weighted sum) of the differences between the acquired images and the modeled images and comparing the result with a corresponding threshold. In another embodiment, image segments of each of the grey calibration regions may be compared with corresponding modeled images of each of the same grey scale calibration regions. In still another embodiment, the one or more image segments of the edge or wedge regions may be compared with corresponding modeled images to compute a spatial resolution of the image acquisition system which may then be compared with a corresponding threshold.

With still further reference to FIG. 7, substantially any imaging acquisition system operational parameters may be adjusted at 158. For example, operational parameters may include camera settings such as focus, aperture, and red, green, blue (RGB) sensor saturation. The operational parameters may also include lighting settings such as light intensity, light temperature, illumination direction, light spectrum or color, and/or power. The physical layout of the imaging acquisition system may also be adjusted, for example, including the distance between the camera lens or sensor and the calibration target. As noted above, the operational parameters may be adjusted manually or automatically. Camera and lighting settings, in particular, may be automatically adjusted such that certain advantageous embodiments of method 150 may include a fully automated calibration method.

It will be understood that the present disclosure includes numerous embodiments. These embodiments include, but are not limited to, the following embodiments.

In a first embodiment, a method for calibrating a digital image acquisition system comprises acquiring a digital image of a calibration target using a digital image acquisition system, the calibration target including a plurality of calibration regions and a plurality of identifying features; determining corresponding locations of each of the plurality of identifying features in the digital image; computing distances between selected ones of the plurality of identifying features in the digital image; and overlaying a calibration grid on the acquired digital image, the calibration grid obtained by processing a location of a reference one of the plurality of identifying features in the acquired digital image, the computed distances between the selected ones of the plurality of identifying features, and known locations of the plurality of calibration regions with respect to the reference one of the plurality of identifying features in the calibration target to compute the calibration grid, the calibration grid specifying a plurality of calibration areas that correspond to the plurality of calibration regions in the calibration target.

A second embodiment may include the first embodiment, further comprising extracting an image segment from the digital image from a corresponding one of the plurality of calibration areas in the calibration grid; obtaining a modeled image of the corresponding one of the plurality of areas in the calibration grid; and adjusting a parameter of the image acquisition system when a difference between the extracted image segment and the modeled image exceeds a threshold.

A third embodiment may include the second embodiment, wherein the adjusting a parameter of the image acquisition system is performed automatically in response to the difference between the extracted portion and the modeled image.

A fourth embodiment may include any one of the first through third embodiments, wherein the calibration target includes a plurality of colored calibration regions and the method further comprises extracting a plurality of image segments from the digital image from the corresponding colored calibration regions in the calibration grid; obtaining a plurality of modeled images of the plurality of colored calibration regions; and adjusting a light source in the digital image acquisition system when a sum of differences between the plurality of image segments and the plurality of modeled images exceeds a threshold.

A fifth embodiment may include any one of the first through fourth embodiments, wherein the calibration target includes a plurality of grey scale calibration regions, and the method further comprises extracting a plurality of image segments from the digital image from the corresponding grey scale calibration regions in the calibration grid obtaining a plurality of modeled images of the plurality of grey scale calibration regions; and adjusting a light source in the digital image acquisition system when a sum of differences between the plurality of image segments and the plurality of modeled images exceeds a threshold.

A sixth embodiment may include any one of the first through fifth embodiments, wherein the calibration target includes an edge contrast calibration region, and the method further comprises extracting an image segment from the digital image from the edge contrast calibration region in the calibration grid; obtaining a modeled image of the edge contrast calibration region; minimizing a difference between the image segment and the modeled image to estimate a spatial resolution of the digital image; and adjusting a focus setting on a digital camera in the digital image acquisition system when the spatial resolution of the digital image exceeds a threshold.

A seventh embodiment may include any one of the first through sixth embodiments, wherein the processing the digital image to determine the corresponding locations of each of the plurality of identifying features in the digital image comprises applying a binary thresholding filter to the acquired digital image to obtain a filtered binary image in which the plurality of identifying features remain; extracting at least one shape property from each remaining feature in the filtered binary image; and evaluating the at least one shape property to determine the corresponding locations of each of the plurality of identifying features.

An eighth embodiment may include the seventh embodiment, wherein the processing the digital image to determine the corresponding locations of each of the plurality of identifying features in the digital image further comprises identifying a plurality of evaluating regions corresponding to the plurality of identifying features; extracting a property from each of the evaluating regions; and evaluating the extracted property to classify one of the plurality of identifying features as the reference one of the plurality of identifying features.

A ninth embodiment may include the eighth embodiment, wherein each of the plurality of evaluating regions is located adjacent to one of the plurality of identifying features; and the extracted property is an intensity.

A tenth embodiment may include any one of the first through ninth embodiments, wherein the computing the calibration grid further comprises computing first and second orthogonal unit vectors u and v between the reference one of the plurality of identifying features and another feature in the calibration target; and computing a location of each of the plurality of calibration areas as a₁u+a₂v, wherein a₁ and a₂ are integers defining locations of each of the plurality of the calibration regions in the calibration target.

In an eleventh embodiment a system for taking calibrated digital images comprises a digital camera; and a processor configured to: cause the digital camera to take a digital image of a calibration target including a plurality of calibration regions and a plurality of identifying features; determine corresponding locations of each of the plurality of identifying features in the digital image; compute distances between the locations of selected ones of the plurality of identifying features in the digital image; and compute a calibration grid that overlays the acquired digital image by processing a location of a reference one of the plurality of identifying features in the acquired digital image, the computed distances between the selected ones of the plurality of identifying features, and known locations of the plurality of calibration regions with respect to the reference one of the plurality of identifying features in the calibration target, the calibration grid specifying a plurality of calibration areas that correspond to the plurality of calibration regions in the calibration target.

A twelfth embodiment may include the eleventh embodiment, further comprising a light source configured to illuminate the calibration target.

A thirteenth embodiment may include the twelfth embodiment, wherein the processor is further configured to: extract an image segment from the digital image from a corresponding one of the plurality of calibration areas in the calibration grid; obtain a modeled image of the corresponding one of the plurality of areas in the calibration grid; and automatically adjusting a parameter of the light source or the digital camera when a difference between the extracted image segment and the modeled image exceeds a threshold.

A fourteenth embodiment may include any one of the eleventh through thirteenth embodiments, wherein the processor is configured to: apply a binary thresholding filter to the acquired digital image to obtain a filtered binary image in which the plurality of identifying features remain; extract at least one shape property from each remaining feature in the filtered binary image; and evaluate the at least one shape property to determine the corresponding locations of each of the plurality of identifying features.

A fifteenth embodiment may include the fourteenth embodiment, wherein the processor is further configured to: identify a plurality of evaluating regions corresponding to the plurality of identifying features; extract a property from each of the evaluating regions; and evaluate the extracted property to classify one of the plurality of identifying features as the reference one of the plurality of identifying features.

In a sixteenth embodiment, a method for calibrating a digital image acquisition system comprise acquiring a digital image of a calibration target using a digital image acquisition system, the calibration target including a plurality of calibration regions and a plurality of identifying features; applying a binary thresholding filter to the acquired digital image to obtain a filtered binary image in which the plurality of identifying features remain; extracting at least one shape property for each remaining feature in the filtered binary image; evaluating the at least one shape property for each of the remaining features to determine locations of the plurality of identifying features; classifying one of the plurality of identifying features as a reference feature; computing distances between the locations of selected ones of the plurality of identifying features in the digital image; and computing a calibration grid that overlays the acquired digital image by processing known locations of the plurality of calibration regions with respect to the reference feature, the location of the reference feature, and the computed distances, the calibration grid specifying a plurality of areas that correspond to the plurality of calibration regions in the calibration target.

A seventeenth embodiment may include the sixteenth embodiment, further comprising extracting an image segment from the digital image from a corresponding one of the plurality of calibration areas in the calibration grid; obtaining a modeled image of the corresponding one of the plurality of areas in the calibration grid; and automatically adjusting a parameter of the image acquisition system when a difference between the extracted image segment and the modeled image exceeds a threshold.

An eighteenth embodiment may include any one of the sixteenth through seventeenth embodiments, wherein the classifying one of the plurality of identifying features as a reference feature comprises identifying a plurality of evaluating regions corresponding to the plurality of identifying features; extracting a property from each of the evaluating regions; and evaluating the extracted property to classify one of the plurality of identifying features as the reference one of the plurality of identifying features.

A nineteenth embodiment may include the eighteenth embodiment, wherein each of the plurality of evaluating regions is located adjacent to one of the plurality of identifying features; and the extracted property is an intensity.

A twentieth embodiment may include any one of the sixteenth through nineteenth embodiments, wherein the computing the calibration grid further comprises computing first and second orthogonal unit vectors u and v between the reference one of the plurality of identifying features and another feature in the calibration target; and computing a location of each of the plurality of calibration areas as a₁u+a₂v, wherein a₁ and a₂ are integers defining locations of each of the plurality of the calibration regions in the calibration target.

Although an integrated mobile system for formation rock analysis has been described in detail, it should be understood that various changes, substitutions and alternations can be made herein without departing from the spirit and scope of the disclosure as defined by the appended claims.

1. A method for calibrating a digital image acquisition system, the method comprising:
acquiring a digital image of a calibration target using a digital image acquisition system, the calibration target including a plurality of calibration regions and a plurality of identifying features;
determining corresponding locations of each of the plurality of identifying features in the digital image;
computing distances between selected ones of the plurality of identifying features in the digital image; and
computing a calibration grid and overlaying the calibration grid on the acquired digital image, the calibration grid computed using a location of a reference one of the plurality of identifying features in the acquired digital image, the computed distances between the selected ones of the plurality of identifying features, and known locations of the plurality of calibration regions with respect to the reference one of the plurality of identifying features in the calibration target, the calibration grid specifying a plurality of calibration areas that correspond to the plurality of calibration regions in the calibration target.

2. The method of claim 1, further comprising:
extracting an image segment from the digital image from a corresponding one of the plurality of calibration areas in the calibration grid;
obtaining a modeled image of the corresponding one of the plurality of areas in the calibration grid; and
adjusting a parameter of the image acquisition system when a difference between the extracted image segment and the modeled image exceeds a threshold wherein adjusting the parameter of the image acquisition system is performed automatically in response to the difference between the extracted portion and the modeled image.

3. The method of claim 1, wherein the calibration target includes a plurality of colored calibration regions and the method further comprises:
extracting a plurality of image segments from the digital image from the corresponding colored calibration regions in the calibration grid;
extracting a plurality of image segments from the digital image from the corresponding grey scale calibration regions in the calibration grid;
obtaining a plurality of modeled images of the plurality of colored calibration regions; and
adjusting a light source in the digital image acquisition system when a sum of differences between the plurality of image segments and the plurality of modeled images exceeds a threshold.

4. The method of claim 1, wherein the calibration target includes an edge contrast calibration region, and the method further comprises:
extracting an image segment from the digital image from the edge contrast calibration region in the calibration grid;
obtaining a modeled image of the edge contrast calibration region;
minimizing a difference between the image segment and the modeled image to estimate a spatial resolution of the digital image; and
adjusting a focus setting on a digital camera in the digital image acquisition system when the spatial resolution of the digital image exceeds a threshold.

5. A system for taking calibrated digital images, the system comprising:
a digital camera; and
a processor configured to:
cause the digital camera to take a digital image of a calibration target including a plurality of calibration regions and a plurality of identifying features;
determine corresponding locations of each of the plurality of identifying features in the digital image;
compute distances between the locations of selected ones of the plurality of identifying features in the digital image; and
compute a calibration grid that overlays the acquired digital image using a location of a reference one of the plurality of identifying features in the acquired digital image, the computed distances between the selected ones of the plurality of identifying features, and known locations of the plurality of calibration regions with respect to the reference one of the plurality of identifying features in the calibration target, the calibration grid specifying a plurality of calibration areas that correspond to the plurality of calibration regions in the calibration target.

6. The system of claim 5, further comprising a light source configured to illuminate the calibration target and wherein the processor is further configured to:
extract an image segment from the digital image from a corresponding one of the plurality of calibration areas in the calibration grid;
obtain a modeled image of the corresponding one of the plurality of areas in the calibration grid; and
automatically adjusting a parameter of the light source or the digital camera when a difference between the extracted image segment and the modeled image exceeds a threshold.

7. A method for calibrating a digital image acquisition system, the method comprising:
acquiring a digital image of a calibration target using a digital image acquisition system, the calibration target including a plurality of calibration regions and a plurality of identifying features;
applying a binary thresholding filter to the acquired digital image to obtain a filtered binary image in which the plurality of identifying features remain;
extracting at least one shape property for each remaining feature in the filtered binary image;
evaluating the at least one shape property for each of the remaining features to determine locations of the plurality of identifying features;
classifying one of the plurality of identifying features as a reference feature;
computing distances between the locations of selected ones of the plurality of identifying features in the digital image; and
computing a calibration grid that overlays the acquired digital image using known locations of the plurality of calibration regions with respect to the reference feature, the location of the reference feature, and the computed distances, the calibration grid specifying a plurality of areas that correspond to the plurality of calibration regions in the calibration target.

8. The method of claim 7, wherein the classifying one of the plurality of identifying features as a reference feature comprises:
identifying a plurality of evaluating regions corresponding to the plurality of identifying features;
extracting a property from each of the evaluating regions; and
evaluating the extracted property to classify one of the plurality of identifying features as the reference one of the plurality of identifying features.

9. The method of claim 8, wherein:
each of the plurality of evaluating regions is located adjacent to one of the plurality of identifying features; and
the extracted property is an intensity.

10. The method of claim 7, wherein the computing the calibration grid further comprises:
computing first and second orthogonal unit vectors u and v between the reference one of the plurality of identifying features and another feature in the calibration target; and
computing a location of each of the plurality of calibration areas as a₁u+a₂v, wherein a₁ and a₂ are integers defining locations of each of the plurality of the calibration regions in the calibration target.
